(19) United States
(12) Patent Application Publication
(10) Pub. No.: US 2025/0056113 A1
(43) Pub. Date: Feb. 13, 2025

(54) IMAGE CAPTURE APPARATUS, CONTROL METHOD FOR IMAGE CAPTURE APPARATUS, AND NON-TRANSITORY COMPUTER-READABLE STORAGE MEDIUM STORING COMPUTER PROGRAM

(71) Applicant: CANON KABUSHIKI KAISHA, Tokyo (JP)

(72) Inventor: KENTA NAKAMURA, Kanagawa (JP)

(21) Appl. No.: 18/767,246

(22) Filed: Jul. 9, 2024

(30) Foreign Application Priority Data
Aug. 10, 2023 (JP) 2023-131469

(51) Int. Cl. H04N 23/63; H04N 23/67

(52) U.S. Cl. CPC H04N 23/635; H04N 23/67

(57) ABSTRACT

An image capture apparatus comprising: an output unit that outputs an image generated by an image capture unit capturing an image of a subject and first data relating to the image capture apparatus at least including data indicating an image capturing direction of when the image capture unit captures the image of the subject; and a control unit that, in a case where the image output is a moving image, updates the first data and causes the output unit to output the updated first data and, in a case where the image is a still image generated by pausing the moving image, from a time corresponding to the still image, does not update at least data indicating the image capturing direction in the first data and causes the output unit to output the first data without updating data indicating the image capturing direction.

### BACKGROUND OF THE INVENTION

### Field of the Invention

The present invention relates to an image capture apparatus, a control method for an image capture apparatus, and a non-transitory computer-readable storage medium storing a computer program.

### Description of the Related Art

Cameras used in publishing images such as moving images and still images include a fixed type that captures images with an overall fixed field of view for capturing an image and a pan-tilt-zoom (PTZ) type that captures images while appropriately switching or moving between a plurality of subjects within an imageable field of view. With PTZ cameras, the imaging angle of view is pre-registered for important subjects. Registering an imaging angle of view is typically referred to as presetting. A known camera transmits still images while a PTZ camera is driven and controlled according to preset registration information. The technique disclosed in Japanese Patent Laid-Open No. 2009-188975 includes transmitting still images obtained from captured images while a camera is controlled to be driven to preset PTZ positions.

Another recent known technique includes transmitting camera data associated with a captured image captured by a camera to an apparatus external to the camera in real time. This camera data includes mainly the position of the camera, the orientation of the camera, lens information, and the like and is used to report the camera state at the time of image capture to an external device. For example, with the technique disclosed in Japanese Patent Laid-Open No. 2011-35638, camera data is input into a computer graphics (CG) image generating apparatus from a real video image camera provided with a unit for detecting camera operation information based on a user operation, and a CG image based on the camera operation information being applied to a viewpoint in a virtual space is repeatedly combined with a real video image.

The camera data influences the camera field of view and the imaging effects such as the camera position, the camera imaging direction, lens information, and the like. The camera data needs to be data associated with each frame image of the moving image. However, in an example such as Japanese Patent Laid-Open No. 2011-35638, camera data is updated according to a camera operation driven by preset registration information even while a still image of a temporarily paused moving image is being transmitted. Thus, there may be an issue in which the camera data is not associated with a still image of a paused moving image being output.

### SUMMARY OF THE INVENTION

According to one aspect of the present disclosure, there is provided an image capture apparatus comprising: an output unit that outputs an image generated by an image capture unit capturing an image of a subject and first data relating to the image capture apparatus at least including data indicating an image capturing direction of when the image capture unit captures the image of the subject; and a control unit that, in a case where the image output is a moving image, updates the first data and causes the output unit to output the updated first data and, in a case where the image is a still image generated by pausing the moving image, from a time corresponding to the still image, does not update at least data indicating the image capturing direction in the first data and causes the output unit to output the first data without updating data indicating the image capturing direction.

According to another aspect of the present disclosure, there is provided a control method for an image capture apparatus comprising: outputting an image generated by an image capture unit capturing an image of a subject and first data relating to the image capture apparatus at least including data indicating an image capturing direction of when the image capture unit captures the image of the subject; and in a case where the image output is a moving image, updating the first data and outputting the updated first data and, in a case where the image is a still image generated by pausing the moving image, from a time corresponding to the still image, not updating at least data indicating the image capturing direction in the first data and outputting the first data without updating data indicating the image capturing direction.

According to another aspect of the present disclosure, there is provided a non-transitory computer-readable storage medium storing a computer program that when read and executed by a computer, causes the computer to output an image generated by an image capture unit capturing an image of a subject and first data relating to the image capture apparatus at least including data indicating an image capturing direction of when the image capture unit captures the image of the subject; and in a case where the image output is a moving image, update the first data and output the updated first data and, in a case where the image is a still image generated by pausing the moving image, from a time corresponding to the still image, not update at least data indicating the image capturing direction in the first data and output the first data without updating data indicating the image capturing direction.

Further features of the present invention will become apparent from the following description of exemplary embodiments (with reference to the attached drawings).

### BRIEF DESCRIPTION OF THE DRAWINGS

FIG. 1 is a configuration diagram of an imaging system.

FIG. 2 is a hardware configuration diagram of an image capture apparatus.

FIG. 3 is a hardware configuration diagram of an information processing apparatus.

FIG. 4 is a functional block diagram of an image capture apparatus.

FIG. 5 is an example of camera data.

FIG. 6 is a functional block diagram of an information processing apparatus.

FIG. 7 is a flowchart illustrating the operations of an image capture apparatus according to a first embodiment.

FIG. 8 is a flowchart illustrating the operations of an image capture apparatus according to a second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

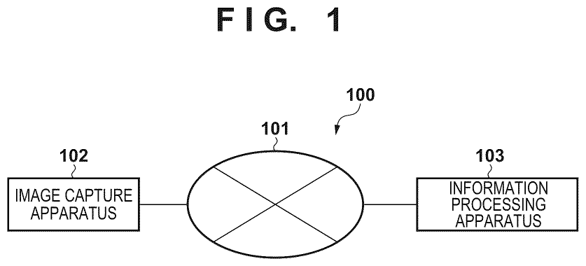

The first embodiment will be described below. FIG. 1 is a diagram illustrating an example of the configuration of an imaging system according to the present embodiment. In an imaging system 100 according to the present embodiment, when an image capture apparatus 102 outputs a captured image to an information processing apparatus 103, the image capture apparatus 102 determines whether the image being output is being output as a moving image or the image is being output as a still image of a temporarily paused moving image and simultaneously outputs camera data associated with the moving image. Specifically, the image capture apparatus 102 updates and outputs the camera data associated with each frame image of the moving image when the moving image is being output. On the other hand, when the image capture apparatus 102 outputs a still image, the still image is output without updating a part of the camera data associated with the still image. Note that the camera data according to the present embodiment is output for the purpose of controlling the viewpoint of a virtual space of when computer graphics (CG) are generated in the virtual space linked with the operation of the image capture apparatus 102 on the information processing apparatus 103, for example.

### System Configuration

The imaging system 100 includes a network 101, the image capture apparatus 102, and the information processing apparatus 103.

The network 101 includes at least one of the Internet, a wired or wireless local area network (LAN), and a wide area network (WAN). The network 101 includes a plurality of routers, switches, and cables compliant with a communication standard such as Ethernet (registered trademark), for example. Note that as long as the network 101 is configured to enable communication between the image capture apparatus 102 and the information processing apparatus 103, the network 101 may be any communication standard, scale, and configuration.

The image capture apparatus 102 is a digital camera that can capture an image of a subject, convert the optical signal into an electrical signal, generate an image such as a moving image and a still image, and output this to an external apparatus. The image capture apparatus 102 captures an image of a subject in real space and generates image data of a moving image or still image. The image capture apparatus 102, in response to a request from the information processing apparatus 103, outputs the generated image data to the information processing apparatus 103 via the network 101. Hereinafter, “image” is used as a term that includes “image” and “image data” in its meaning. The image capture apparatus 102 may proactively output an image and the like to the information processing apparatus 103 without a request from the information processing apparatus 103. The image capture apparatus 102 outputs at least a part of camera data relating to the image capture apparatus 102 including the current position, orientation, zoom magnification, focus position, pan angle or tilt angle, and the like to the information processing apparatus 103 as camera data. The camera data includes control data necessary for the information processing apparatus 103 to execute the image combining processing described below. The control data is data enabling control of the viewpoint of a virtual space. The control data may include information relating to at least one of the field of view (imaging direction) and the imaging effect of the image capture apparatus 102 as data enabling control of the viewpoint of a virtual space. The camera information included in the camera data may be changed as necessary. It is sufficient that the camera data includes, as data enabling control of the viewpoint of a virtual space, information indicating the imaging direction in which the image capture apparatus 102 is imaging. The information indicating the imaging direction may be, for example, the pan angle, which is an angle in the pan direction (horizontal direction) in the imaging direction in which the image capture apparatus 102 is imaging. Also, the information indicating the imaging direction may be, for example, the tilt angle, which is an angle in the tilt direction (vertical direction) in the imaging direction in which the image capture apparatus 102 is imaging. For example, the pan angle may be an angle represented by a positive numerical value for a position moved to the right of a reference position or represented by a negative numerical value for a position moved to the left. Also, for example, the pan angle may be an angle represented by a positive numerical value for a position moved up from a horizontal position or represented by a negative numerical value for a position moved down. The information indicating the imaging direction as described above can represent the pan angle and the tilt angle. However, it is not necessarily an angle, and may represent two-dimensional coordinates using a predetermined position as a reference.

Also, the information indicating the imaging direction being used for controlling the viewpoint of a virtual space is just an example, and the information indicating the imaging direction may have a different use. For example, it may be used to change the position for displaying predetermined information in a captured image. As long as, in the embodiments, the camera data is camera data (in particular, information indicating the imaging direction) associated with a still image of a paused moving image being output by an image capture apparatus, various methods for using this camera data can be conceived.

The information processing apparatus 103 sets and controls the viewpoint in a virtual space on the basis of the camera data received from the image capture apparatus 102 via the network 101. The information processing apparatus 103 generates a virtual space image (CG) of a virtual space as seen from the set viewpoint. The information processing apparatus 103 combines the generated virtual space image and the image received from the image capture apparatus 102 via the network 101 and generates a combined image. In this manner, the information processing apparatus 103 can display an image that looks as if the subject in the real space exists in the virtual space. The information processing apparatus 103 may be a computer such as a personal computer, a tablet terminal, a smartphone, or the like, for example. The information processing apparatus 103 can manipulate the object in the virtual space on the basis of the received camera data. For example, the information processing apparatus 103 may manipulate the viewpoint in the virtual space as an object of the image capture apparatus 102 on the basis of control data included in the camera data.

### Apparatus Configuration

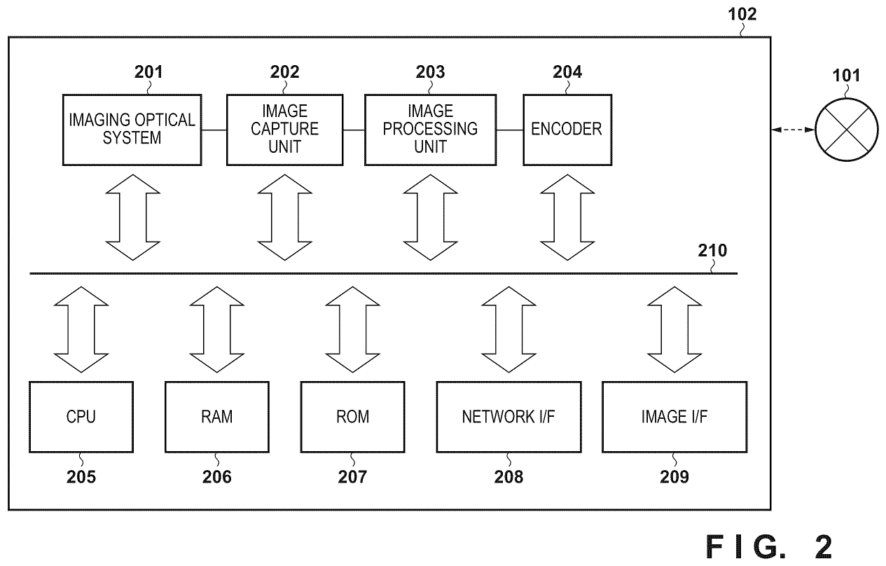

FIG. 2 is a diagram illustrating an example of the hardware configuration of an image capture apparatus according to the present embodiment. The image capture apparatus 102 includes an imaging optical system 201, an image capture unit 202, an image processing unit 203, an encoder 204, a central processing unit (CPU) 205, random-access memory (RAM) 206, read-only memory (ROM) 207, a network interface (I/F) 208, an image I/F 209, and a bus 210. The imaging optical system 201, the image capture unit 202, the image processing unit 203, the encoder 204, the CPU 205, the RAM 206, the ROM 207, the network I/F 208, and the image I/F 209 are connected via the bus 210 in a manner allowing for data to be exchanged with one another. The CPU 205, the RAM 206, the ROM 207, and the like function as a computer.

The imaging optical system 201 is a lens that focuses light from a subject onto an imaging plane of the image capture unit 202 and is configured of a zoom lens, a focus lens, a blur correction lens, and the like, for example. In the present embodiment, the imaging optical system 201 is integrally formed with the image capture apparatus 102, but it may be a detachable system such as an interchangeable lens. The imaging optical system 201 moves the lens to change the optical zoom magnification on the basis of a user operation, adjust the focus position according to the distance to the subject, and the like.

The image capture unit 202 is an image sensor that captures an image of a subject. The image capture unit 202 is, for example, a charge coupled device (CCD), a complementary metal oxide semiconductor (CMOS), or the like. The image capture unit 202 converts light from a subject via the imaging optical system 201 and converts the light in an electrical signal to capture an image of the subject and generate an image.

The image processing unit 203 converts the electrical signal from the image capture unit 202 into a digital signal via A/D conversion. The image processing unit 203 executes various types of image processing on the image converted to a digital signal including color interpolation processing, demosaicing processing, white balance processing, gamma processing, and the like.

The encoder 204 executes processing to encode the post-image-processing image into a file format such as Motion JPEG, H264, H265, or the like and outputs it. The post-encoding-processing image data is output to the information processing apparatus 103 via the network 101.

The CPU 205 is a central processing unit that comprehensively controls the image capture apparatus 102. The CPU 205 executes at least a part of the functions described below of the image capture apparatus 102 by reading out a program loaded from the ROM 207 onto the RAM 206.

The RAM 206 provides a working area used by the CPU 205 when executing the program, functions as frame memory, and functions as buffer memory.

The ROM 207 stores programs for the CPU 205 to control the image capture apparatus 102, image data, and the like. Note that the image capture apparatus 102 may include storage such as a hard disk drive (HDD), a solid state drive (SSD), or the like instead of or in addition to the ROM 207.

The network I/F 208 is connected to the information processing apparatus 103 via the network 101. The CPU 205 outputs images and camera data via the network I/F 208 in response to a request from the information processing apparatus 103.

The image I/F 209 is an image output terminal and is, for example, a serial digital interface (SDI), a high-definition multimedia interface (HDMI, registered trademark), or the like. The CPU 205 may output image signals to a display device and the like via the image I/F 209.

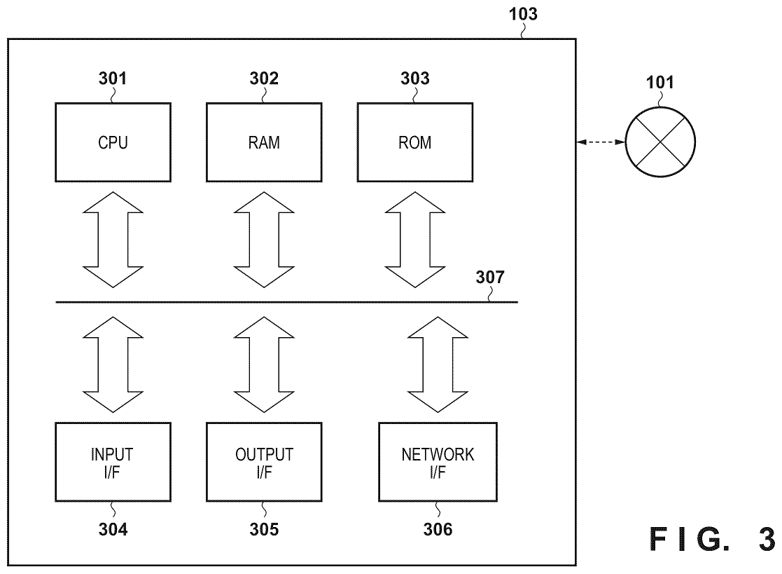

FIG. 3 is a diagram illustrating an example of the hardware configuration of the information processing apparatus 103 according to the present embodiment. The information processing apparatus 103 includes a CPU 301, RAM 302, ROM 303, an input I/F 304, an output I/F 305, a network I/F 306, and a bus 307. The CPU 301, the RAM 302, the ROM 303, the input I/F 304, the output I/F 305, and the network I/F 306 are connected via the bus 307 in a manner allowing for data to be exchanged with one another.

The CPU 301 is a central processing unit that comprehensively controls the information processing apparatus 103. The CPU 301 executes at least a part of the functions described below of the information processing apparatus 103 by reading out a program loaded from the ROM 303 onto the RAM 302.

The RAM 302 provides a working area used by the CPU 301 when executing the program, functions as frame memory, and functions as buffer memory.

The ROM 303 stores programs for the CPU 301 to control the information processing apparatus 103, image data, and the like. The information processing apparatus 103 may include storage such as a HDD, SSD, or the like instead of or in addition to the ROM 303.

The input I/F 304 is an interface such as a keyboard or a mouse for accepting input from a user. The user may input coordinates of a viewpoint position in a virtual space, an angle of view, a viewpoint direction, and the like via the input I/F 304.

The output I/F 305 is an interface for outputting an image to be displayed on the display. The output I/F 305, according to an instruction from the CPU 301, outputs and displays the image captured by the image capture apparatus 102, the virtual space image (CG), or the combined image of the image captured by the image capture apparatus 102 and the virtual space image on the display.

The network I/F 306 is connected to the image capture apparatus 102 via the network 101. The network I/F 306 receives the images, camera data, and the like output from the image capture apparatus 102.

### Functional Configuration

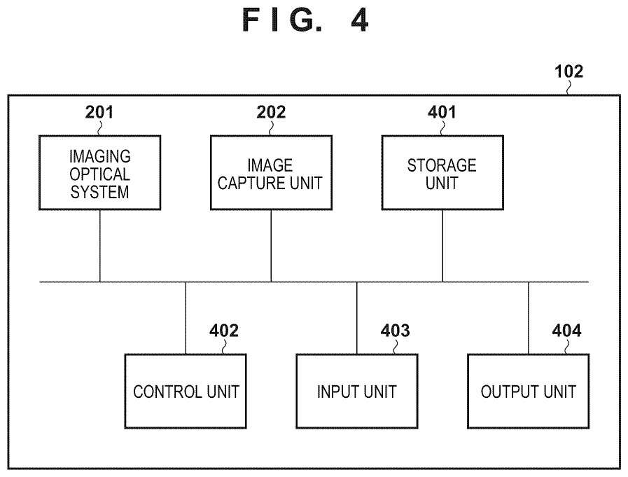

The functional configuration of an image capture apparatus according to the present embodiment will now be described with reference to FIG. 4. FIG. 4 is a block diagram illustrating an example of the functional configuration of the image capture apparatus 102 according to the present embodiment. The image capture apparatus 102 includes the imaging optical system 201, the image capture unit 202, a storage unit 401, a control unit 402, an input unit 403, and an output unit 404.

The functions performed by the imaging optical system 201 and the image capture unit 202 are as described regarding the apparatus configuration and thus will not be described here. Also, of the functional blocks, the functions implemented by software are implemented via a program stored in the storage unit 401 such as the ROM 207 or the like.

The CPU 205 reads out a program from the ROM 207 onto the RAM 206 and executes the program to implement the functions of the control unit 402, the input unit 403, the output unit 404, and the like. The functions implemented by hardware, for example, are implemented by automatically generating a dedicated circuit on the FPGA from a program for implementing the function of each functional block using a predetermined compiler, for example. FPGA is an abbreviation for a field programmable gate array. Each function may be implemented as hardware by forming a gate array circuit as with the FPGA. Each function may be implemented by an application specific integrated circuit (ASIC). Note that the configurations of the functional blocks illustrated in FIG. 4 are examples, and a plurality of functional blocks may constitute one functional block, or any of the functional blocks may be split into a block that performs a plurality of functions.

The storage unit 401 stores captures images, current camera data, and the like. The current camera data is set and updated according to an operation of the image capture apparatus 102 calculated on the basis of data detected by a sensor installed in the image capture apparatus 102. The storage unit 401 stores a setting for temporarily pausing the image in order to generate a still image at the time of a preset operation.

The control unit 402 entirely controls the image capture apparatus 102. The control unit 402 controls the imaging optical system 201 and the image capture unit 202 on the basis of a user operation. Specifically, the control unit 402 controls the pan angle, the tilt angle, the zoom position, the focus position, and the like of the imaging optical system 201 and sets and changes parameters such as the exposure time, gain, and the like relating to image capture by the image capture unit 202. The control unit 402 controls input, output, and the like of images and camera data. For example, the control unit 402 stores captured images and camera data in the storage unit 401. The control unit 402 obtains a control command such as a preset operation command input by a user from the input unit 403. The control unit 402 outputs the images and camera data stored in the storage unit 401 to the information processing apparatus 103 via the output unit 404.

In a case where the control unit 402 outputs a moving image as an image, the control unit 402 reads out the camera data including control data, which is data for controlling the viewpoint of the virtual space, from the stored camera information to update and output the camera data each time a frame image is output. In a case where the control unit 402 outputs a still image as an image, the control unit 402 outputs the camera data without updating the control data for controlling the viewpoint of the virtual space in the camera data. Note that the control unit 402 may update and output the camera data excluding the control data in the case of outputting a still image.

Information is input into the input unit 403 via the network 101. In the present embodiment, a control command for the image capture apparatus 102 is input into the input unit 403. A control command includes a preset operation command and a command to change the setting for obtaining a still image by temporarily pausing a moving image at the time of a preset operation. The preset operation command includes preset identification information, pan-tilt-zoom (PTZ) coordinate information, control information of parameters such as exposure time and gain relating to image capture by the image capture unit 202, and the like.

The output unit 404 outputs images and camera data according to control performed by the control unit 402. The output unit 404 outputs camera data including control data for controlling, for example, the orientation and position of the image capture apparatus 102 and the viewpoint in the virtual space including the zoom position and focus position of the imaging optical system 201.

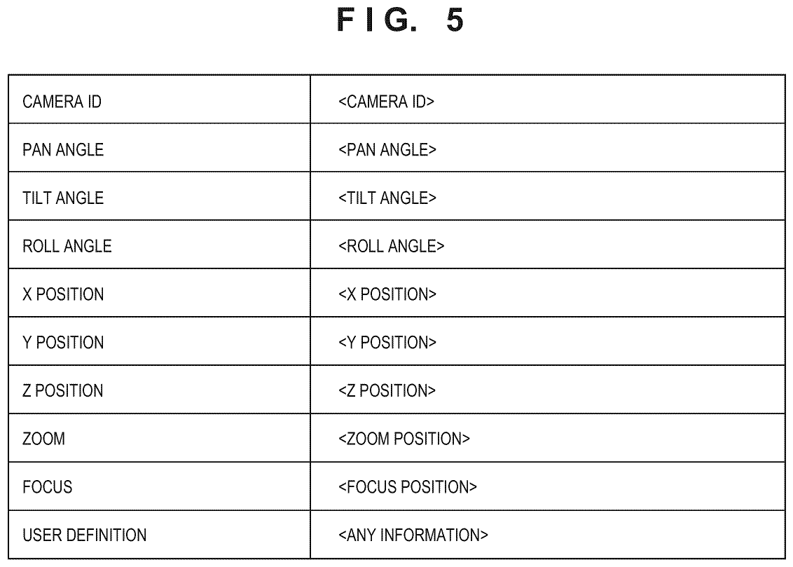

An example of the camera data will now be described with reference to FIG. 5. FIG. 5 is a diagram illustrating an example of the camera data. The camera data is data based on the free-D protocol, the HF protocol, or the like, for example. Specifically, the camera data includes a camera ID, pan angle, tilt angle, roll angle, X position, Y position, Z position, zoom, focus, and any such information. In this manner, the camera data includes control data for controlling the viewpoint in a virtual space. The camera data includes at least one of the position and orientation of the image capture apparatus 102 (information indicating the imaging direction) and the zoom position and the focus position of the imaging optical system 201 as control data relating to the viewpoint in a virtual space.

The camera ID of the camera data is an ID unique to the image capture apparatus 102 or an ID for the image capture apparatus 102 set at the discretion of the user.

The pan angle, tilt angle, and roll angle of the camera data correspond to the pan angle, tilt angle, and roll angle representing the orientation of the image capture apparatus 102. Here, the pan angle, tilt angle, and roll angle of the camera information stored in a storage unit such as the ROM 207 are updated by the data obtained by a sensor or the like attached to the image capture apparatus 102. In a case where a moving image is being output, the pan angle, tilt angle, and roll angle of the camera data are updated by reading out the pan angle, tilt angle, and roll angle of the camera information from the storage unit. Thus, the camera information is associated with each frame image of the moving image. On the other hand, in a case where a still image of a paused moving image is being output, the pan angle, tilt angle, and roll angle of the camera data are not read out from the storage unit and updated. Thus, the camera information is associated with the still image.

The X position, Y position, and Z position of the camera data correspond to the coordinate values indicating the position of the image capture apparatus 102 obtained by a sensor or the like attached to the image capture apparatus 102. Here, the X position, Y position, and Z position of the camera information stored in a storage unit such as the ROM 207 are updated by the data obtained by a sensor or the like attached to the image capture apparatus 102. In a case where a moving image is being output, the X position, Y position, and Z position of the camera data are updated by reading out the X position, Y position, and Z position of the camera information from the storage unit. Thus, the camera information is associated with each frame image of the moving image. On the other hand, in a case where a still image of a paused moving image is being output, the X position, Y position, and Z position of the camera data are not read out from the storage unit and updated. Thus, the camera information is associated with the still image.

The zoom and focus of the camera data is information indicating the zoom position and focus position of the imaging optical system 201. Here, the zoom position and focus position of the camera information stored in a storage unit such as the ROM 207 are updated by the data obtained by a sensor or the like attached to the image capture apparatus 102. In a case where a moving image is being output, the zoom position and focus position of the camera data are updated by reading out the zoom position and focus position of the camera information from the storage unit. Thus, the camera information is associated with each frame image of the moving image. On the other hand, in a case where a still image of a paused moving image is being output, the zoom position and focus position of the camera data are not read out from the storage unit and updated. Thus, the camera information is associated with the still image.

The user definition of the camera data is any information set in the image capture apparatus 102. The user definition may include information of the time relating to still image output. The time relating to still image output may be information such as the remaining stoppage time in the case of outputting a still image of a temporarily paused moving image, for example.

The control data of the camera data described above is an example and may include, as data enabling control of the viewpoint of a virtual space, data that influences at least one of the field of view and the imaging effect of the image capture apparatus 102. Specifically, the control data may include information relating to the iris of the image capture apparatus 102, the white balance, the gain, and lens distortion correction parameter, and the imaging condition setting. In this manner, the information processing apparatus 103 can control the depth of field of an image in the virtual space, the balance of white color, brightness, and distortion on the basis of the control data.

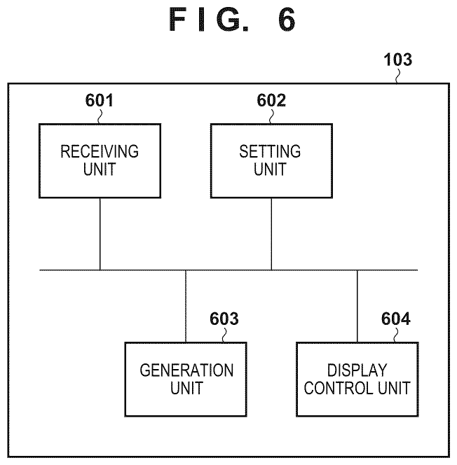

The functional configuration of the information processing apparatus according to the present embodiment will now be described with reference to FIG. 6. FIG. 6 is a diagram illustrating an example of the functional configuration of the information processing apparatus 103 according to the present embodiment. The information processing apparatus 103 includes a receiving unit 601, a setting unit 602, a generation unit 603, and a display control unit 604. The program for implementing the function of each functional block illustrated in FIG. 6 is stored in a storage unit such as the ROM 303. The CPU 301 reads out the program stored in the ROM 303 onto the RAM 302 and executes the program to implement it. The functions implemented by hardware, for example, may be implemented by automatically generating a dedicated circuit on the FPGA from a program for implementing the function of each functional block using a predetermined compiler, for example. Also, each function may be implemented as hardware by forming a gate array circuit as with the FPGA. Furthermore, each function may be implemented by an ASIC. Note that a plurality of functional blocks may constitute one functional block, or any of the functional blocks may be split into a block that performs a plurality of functions.

The receiving unit 601 receives the information output from the image capture apparatus 102. The receiving unit 601 receives images including moving images and still images output from the output unit 404 and camera data, which is camera information relating to the viewpoint in a virtual space.

The setting unit 602 sets and updates the information relating to the viewpoint in a virtual space on the basis of the camera data received at the receiving unit 601.

The generation unit 603 generates a virtual space image on the basis of information relating to the viewpoint in a virtual space set by the setting unit 602. Also, by combining the image received by the receiving unit 601 and the generated virtual space image, the generation unit 603 generates a combined image that looks as if the subject in the real space exists in the virtual space.

The display control unit 604 controls the output I/F 305 so that at least one of the combined image generated by the generation unit 603 or the image obtained by the receiving unit 601 is displayed on the display.

### Description of Operations

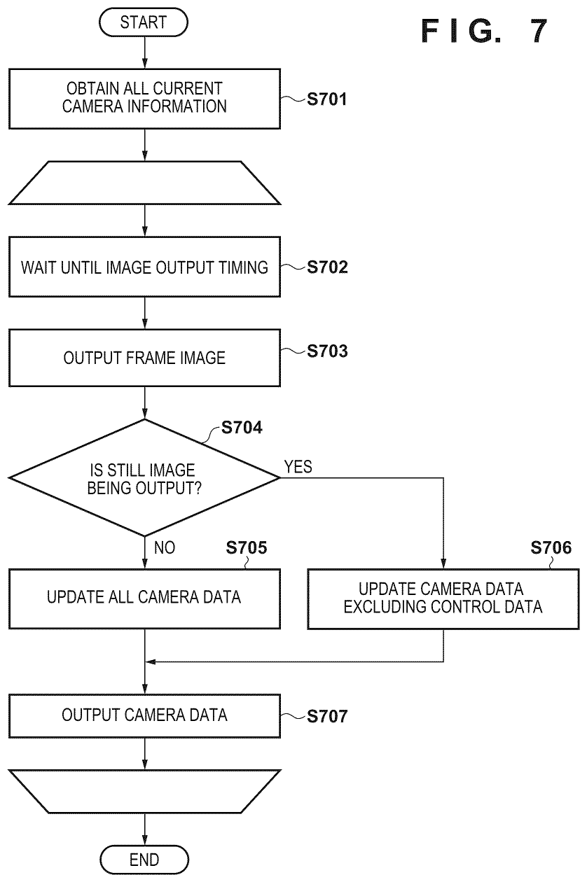

The operations of an image capture apparatus according to the present embodiment will now be described with reference to FIG. 7. FIG. 7 is a flowchart illustrating the operations of the image capture apparatus 102 according to the present embodiment. In the flowchart illustrated in FIG. 7, the operations described in the present flowchart are started by the CPU 205 of the image capture apparatus 102 loading a program stored in the ROM 207 onto the RAM 206 and executing the program.

In S701, the control unit 402 reads out all of the current camera information for forming camera data from the storage unit 401 and generates camera data.

In S702, the control unit 402 waits until the time when an image captured and generated by the image capture unit 202 is output from the output unit 404.

In S703, the control unit 402 outputs the frame image generated at the image capture unit 202 from the output unit 404 to the information processing apparatus 103 via the network 101.

In S704, the control unit 402 determines whether or not a still image is being output from the output unit 404. If the image being output from the output unit 404 is a moving image, the control unit 402 executes S705. If the image being output is a still image of a temporarily paused moving image, the control unit 402 executes S706.

In S705, the control unit 402 updates all of the camera data. Specifically, the control unit 402 reads out all of the current camera information for forming the camera data from the storage unit 401 and updates the camera data. In other words, the control unit 402 generates the latest camera data relating to the orientation, position, zoom, and focus of the image capture apparatus 102, which is control data for controlling the viewpoint in a virtual space being updated by information from a sensor or the like. Accordingly, in a case where a moving image is being output, the control unit 402 generates camera data associated with each frame image of the moving image.

In S706, the control unit 402 updates the camera data excluding the control data. Specifically, the control unit 402 reads out, of the camera information for forming the camera data, the current camera information not related to controlling the viewpoint in a virtual space from the storage unit 401 and updates the camera data excluding the control data. The current camera information not related to controlling the viewpoint in a virtual space is a camera ID, for example. Note that the current camera information not related to controlling the viewpoint in a virtual space may include a frame ID, a time stamp, remaining stoppage time in the case of a temporarily paused moving image, and the like. The control unit 402 does not read out the camera information not related to controlling the viewpoint in a virtual space from the storage unit 401. Thus, the control data included in the camera data is not updated and corresponds to camera data associated with a still image. Note that at least the update of information (pan angle and tilt angle) indicating the imaging direction is stopped.

In S707, the control unit 402 outputs the camera data to the information processing apparatus 103 via the output unit 404.

The control unit 402 determines whether or not to end image capture. If image capture is to end, the operation of the flowchart ends. If image capture is not to end, the process returns to S702.

According to the present embodiment, when the image capture apparatus 102 outputs an image to the information processing apparatus 103, if the image is being output as a moving image, the control unit 402 updates the control data and outputs the camera data. Accordingly, with the present embodiment, camera data including control data associated with the moving image can be output. On the other hand, with the present embodiment, if a still image of a temporarily paused moving image is being output as an image, the control data for controlling the viewpoint of a virtual space included in the camera data is not updated, and camera data including control data associated with the still image can be output. Accordingly, with the present embodiment, appropriate camera data associated with an image can be output regardless of whether the image being output is a moving image or a still image, allowing an appropriate viewpoint of a virtual space to be generated.

With the present embodiment, camera data is updated and generated associated with each frame image of a moving image. Accordingly, with the present embodiment, camera data associated with each frame image can be output and a viewpoint of a virtual space associated with each frame image can be generated.

With the present embodiment, control data including iris information and the like can be generated. Thus, the output destination can generate a viewpoint of a virtual space with higher accuracy.

With the present embodiment, camera data including information of the time relating to still image output is generated. Thus, the still image remaining time and the like can be sent to the output destination.

With the present embodiment, the camera data excluding the control data is updated even if a still image is being output. Thus, a viewpoint of a virtual space can be accurately generated and the camera data excluding the control data can be put in the latest state.

### Second Embodiment

In the first embodiment described above, all of the interfaces for outputting images in the image capture apparatus 102 are linked and an output image is temporarily paused and a moving image is caused to be output. In the present embodiment described herein, in the image capture apparatus 102, for each interface, control of whether to output a moving image or output a still image of a temporarily paused moving image can be changed. The apparatus configuration according to the present embodiment is similar to that of the first embodiment and thus will not be described.

### Description of Functions

The functional configuration according to the present embodiment will now be described. The differences with the first embodiment will be described below, and thus functions similar to those in the first embodiment will not be described.

Information is input into the input unit 403 via the network 101. According to the present embodiment, the information input into the input unit 403 is output destination information of the camera data, associated line information, and the like. The output destination information of the camera data includes the IP address, port number, and the like on the network 101 of the information processing apparatus 103. The associated line information of the camera data is information for associating together the image publishing interface of the image capture apparatus 102 and the camera data and is, for example, IP streaming, serial digital interface (SDI), or the like. Also, information for setting whether or not to output a still image of a temporarily paused moving image per image output interface may be input into the input unit 403.

The storage unit 401 stores at least a part of the output destination information and the associated line information of the camera data input into the input unit 403. The storage unit 401 stores images, camera information input from a sensor, and the like.

The control unit 402 obtains the output destination information and the associated line information of the camera data described above and the like via the input unit 403. The control unit 402 determines the image line to output an image from the associated line information of the camera data and the like. The control unit 402 determines whether the image being output is a moving image or a still image of a temporarily paused moving image on the basis of the determined image line. In a case where it is determined that a moving image is being output, the control unit 402 updates and outputs the camera data including the control data (in particular, the information indicating the imaging direction). In a case where it is determined that a still image is being output, the control unit 402 does not update, of the camera data, the control data (in particular, the information indicating the imaging direction) for controlling the viewpoint of a virtual space and outputs the camera data with the data excluding the control data updated.

The output unit 404 outputs the image and the camera data to the information processing apparatus 103 via the network I/F 208 on the basis of the factors included in the output destination information of the camera data stored in the storage unit 401. Also, the output unit 404 outputs an image via the image line on the basis of information for setting whether or not to output a still image of a temporarily paused image for each image line connected to the image output I/F.

### Description of Operations

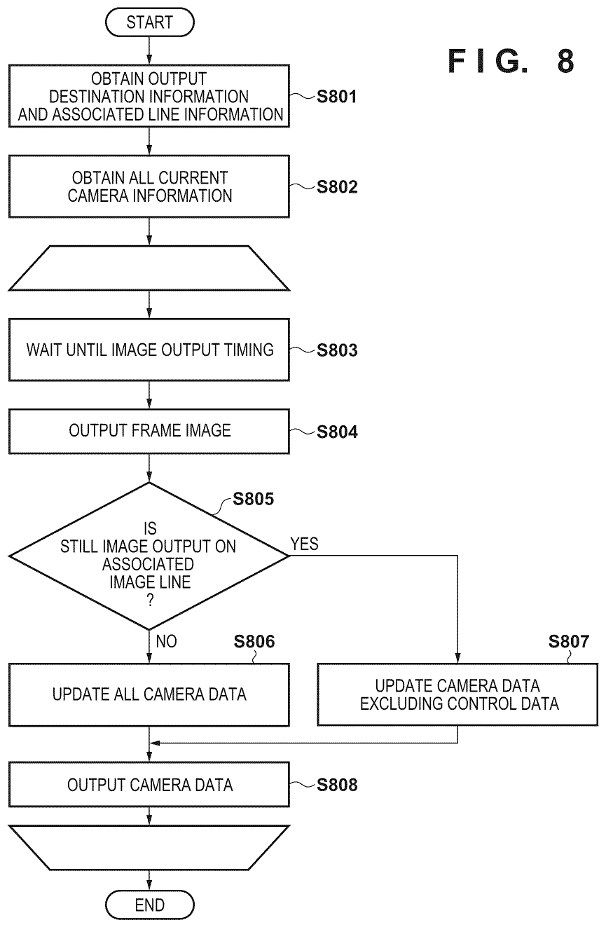

The operations of the image capture apparatus 102 according to the present embodiment will now be described with reference to FIG. 8. FIG. 8 is a flowchart illustrating the operations of the image capture apparatus 102 according to the present embodiment.

In S801, the control unit 402 obtains the output destination information and the associated line information of the camera data input into the input unit 403 from the storage unit 401. In a case where the associated line information of the camera data is stored in the storage unit 401, the control unit 402 may determine the associated line information of the camera data on the basis of the use status of the image line of the image capture apparatus 102 and the output destination information of the camera data. For example, in a case where the IP address of the output destination information of the camera data is the same as the IP address of the output destination of the IP streaming image, the control unit 402 may determine that the associated line information of the camera data is an IP stream. In a case where the image is not being published via IP streaming, the control unit 402 may determine that the associated line information of the camera data is an SDI or the like.

S802 to S804 are similar to S701 to S703 of the flowchart according to the first embodiment and thus will not be described.

In S805, the control unit 402 determines whether or not a still image of a temporarily paused moving image is being output from the associated image line. Specifically, the control unit 402 determines the image line to output from the associated line information of the camera data obtained in S801. The control unit 402 determines whether or not a still image is being output from the determined image line. For example, in a case where the associated line information of the camera data is an SDI, the control unit 402 determines whether or not the image of the SDI line is a still image. In a case where the associated line information of the camera data is an IP stream, the control unit 402 determines whether or not the image of the IP stream line is a still image. In a case where a still image is not being output from the associated image line, the control unit 402 executes S806. In a case where a still image is being output from an image line, S807 is executed.

In S806, the control unit 402 updates all of the camera data. In other words, in a case where an associated image line is outputting a moving image, the control unit 402 updates all of the camera data.

In S807, the control unit 402 updates the camera data excluding the control data (in particular, the information indicating the imaging direction). In other words, in a case where an associated image line is outputting a still image, the control unit 402 does not update the control data (in particular, the information indicating the imaging direction) and generates the camera data excluding the control data.

In S808, the control unit 402 outputs the camera data generated for each image line via the output unit 404.

With the present embodiment, a moving image or a still image can be individually output per image line, allowing the image desired by the user to be output per image line.

With the present embodiment, whether or not to output a still image of a temporarily paused moving image can be changed per image line, and whether or not to update the control data of the camera data is determined by whether or not a still image is being output. Accordingly, the image capture apparatus 102 can appropriately update the camera data per image line according to the image output from the image I/F and image line desired by the user and can output the camera data including the control data associated with the image.

With the present embodiment, the image line is determined by comparing the image output destination and the camera data output destination. Thus, the image line to output the camera data can be accurately determined and appropriate camera data can be generated per image line.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-131469, filed Aug. 10, 2023, which is hereby incorporated by reference herein in its entirety.

What is claimed is:

1. An image capture apparatus comprising:
an output unit that outputs an image generated by an image capture unit capturing an image of a subject and first data relating to the image capture apparatus at least including data indicating an image capturing direction of when the image capture unit captures the image of the subject; and
a control unit that, in a case where the image output is a moving image, updates the first data and causes the output unit to output the updated first data and, in a case where the image is a still image generated by pausing the moving image, from a time corresponding to the still image, does not update at least data indicating the image capturing direction in the first data and causes the output unit to output the first data without updating data indicating the image capturing direction.

2. The image capture apparatus according to claim 1, wherein
the control unit, in a case where the image is the moving image, updates the first data to be associated with each frame image of the moving image.

3. The image capture apparatus according to claim 1, wherein
the first data includes information relating to at least one of a field of view and an image capturing effect as control data enabling control of a viewpoint of a virtual space.

4. The image capture apparatus according to claim 1, wherein
the control unit generates the first data including at least one of information relating to position of the image capture apparatus, orientation of the image capture apparatus, zoom, focus, iris, white balance, gain, distortion correction parameter, and an image capturing condition setting.

5. The image capture apparatus according to claim 1, wherein
the control unit generates the first data including information of time relating to output of the still image.

6. The image capture apparatus according to claim 3, wherein
the control unit, in a case where the image output is the still image, updates and outputs the first data excluding the control data.

7. The image capture apparatus according to claim 1, wherein
the control unit causes the image to be individually output as the moving image or the still image per image line for outputting the image.

8. The image capture apparatus according to claim 7, wherein
the control unit generates the first data according to the image output from the image line.

9. The image capture apparatus according to claim 7, wherein
the control unit determines the image line by comparing an output destination of the image and an output destination of the first data.

10. A control method for an image capture apparatus comprising:
outputting an image generated by an image capture unit capturing an image of a subject and first data relating to the image capture apparatus at least including data indicating an image capturing direction of when the image capture unit captures the image of the subject; and
in a case where the image output is a moving image, updating the first data and outputting the updated first data and, in a case where the image is a still image generated by pausing the moving image, from a time corresponding to the still image, not updating at least data indicating the image capturing direction in the first data and outputting the first data without updating data indicating the image capturing direction.

11. A non-transitory computer-readable storage medium storing a computer program that when read and executed by a computer, causes the computer to
output an image generated by an image capture unit capturing an image of a subject and first data relating to the image capture apparatus at least including data indicating an image capturing direction of when the image capture unit captures the image of the subject; and
in a case where the image output is a moving image, update the first data and output the updated first data and, in a case where the image is a still image generated by pausing the moving image, from a time corresponding to the still image, not update at least data indicating the image capturing direction in the first data and output the first data without updating data indicating the image capturing direction.
